(19) United States
(12) Patent Application Publication
(10) Pub. No.: US 2019/0248058 A1
(43) Pub. Date: Aug. 15, 2019

(54) MIXING ATTACHMENT FOR A SCREW

(71) Applicant: KRAUSSMAFFEI TECHNOLOGIES GMBH, München (DE)

(72) Inventors: Dieter Sladek, München (DE); Erwin Reiber, Karlsfeld (DE)

(21) Appl. No.: 16/338,630

(22) PCT Filed: Oct. 5, 2017
(86) PCT No.: PCT/EP2017/075284

§ 371 Date: Apr. 1, 2019

(30) Foreign Application Priority Data
Oct. 25, 2016 (DE) 10 2016 120 325.4

(51) Int. Cl. B29C 48/25; B29C 48/36; B29C 48/395; B29C 48/575; B29C 48/67

(52) U.S. Cl. CPC B29C 48/2564; B29C 48/363; B29C 48/585; B29C 48/575; B29C 48/67; B29C 48/397

(57) ABSTRACT

A mixing attachment for a screw, in particular an extruder screw in an extruder or in an injection-molding machine, comprising an essentially rotationally symmetrical lateral surface, the diameter of which increases from a first end to a second end of the lateral surface, and a securing device, which is provided in the region of the first end of the lateral surface, for securing the mixing attachment at a downstream end of the screw, wherein the lateral surface is perforated by a plurality of apertures, in particular bores.

The present invention relates to a mixing attachment for a screw, in particular for an extruder screw in an extruder or in an injection-moulding machine.

Such mixing attachments for a downstream tip of an extruder screw at the end of the metering zone of an extruder or respectively of an injection-moulding machine are basically known, e.g. in the form of so-called toothed disc mixers. They serve to improve the mechanical and/or thermal homogeneity of the melt immediately before the discharging of the extrusion material.

In practice, however, furthermore material- and temperature inhomogeneities arise, especially in the case of high material throughput or respectively in situations in which additives such as dyes or fillers are to be mixed uniformly into the melt.

It is therefore an object of the present invention to propose an improved mixing attachment for such a screw.

According to the invention, this problem is solved by a mixing attachment for a screw, in particular for an extruder screw in an extruder or in an injection-moulding machine, comprising an essentially rotationally symmetrical lateral surface, the diameter of which increases from a first end to a second end of the lateral surface, and a securing device, which is provided in the region of the first end of the lateral surface, for securing the mixing attachment at a downstream end of the screw, wherein the lateral surface is perforated by a plurality of apertures, in particular bores.

As the diameter of the lateral surface increases from its first end, where it is secured to the screw, to its second end close to the discharge opening of the extruder or respectively of the injection-moulding machine, accordingly the cross-section of the material channel reduces which is available, in the direction of flow, to the melt in the cylinder of the extruder or respectively of the injection-moulding machine surrounding the screw and the lateral surface. Consequently, the melt diverts under pressure through the apertures or bores in the lateral surface, whereby the material stream is divided into a number of melt stream strands dependent on the number of apertures or bores. This distributive and dispersive mixing of the melt, which is brought about mechanically, involves an intensive temperature- and material exchange, which promotes the homogenization of the temperature distribution and the material homogeneity. This permits an improvement to the mechanical and/or visual characteristics of the produced semi-finished products such as e.g. pipes, profiles, monofilaments, foils, plates, etc.

Preferably, the securing device comprises a thread. In this way, it is ensured that the mixing attachment can be separated from the downstream end of the screw by unscrewing, e.g. in order to replace it because of wear or to mount another mixing attachment according to the invention for the processing of another extrusion material at the screw.

Expediently, provision is made that the lateral surface is formed at least partly in a frustoconical shape. This simplifies the production of the mixing attachment. However, other geometries are also conceivable, as long as it is guaranteed that the diameter of the lateral surface increases from its first end, where it is secured to the screw, to its second end close to the discharge opening of the extruder or respectively of the injection-moulding machine. The cross-section of the material channel between the lateral surface and the inner wall of the surrounding cylinder therefore decreases for the melt in the direction of flow.

The apertures can be configured as bores. However, any desired and optimum geometry (in particular of the cross-section) of the apertures for the respective purpose of use (e.g. according to characteristics of the extrusion material and/or resistance of the tool which is to be filled), such as for example round, oval or angular, such as triangular, four-sided, pentagonal, hexagonal, etc. is conceivable. Also apertures with different geometries can be combined on a lateral surface. For further simplification of the production of the mixing attachment according to the invention, at least a portion of the apertures or bores can perforate the lateral surface essentially orthogonally. Then, the apertures or bores can be realized by perpendicular milling through or drilling through the lateral surface.

In a simple embodiment of the mixing attachment according to the invention, the diameter of the apertures or bores is essentially identical. Then essentially all the apertures or bores can be realized with the same drilling tool.

According to the rheological characteristics of the extrusion material and/or resistance of the tool which is to be filled, embodiments of the mixing attachments according to the invention are also conceivable, in which the apertures or bores have different diameters or geometries. In particular, hereby an essentially identical material throughflow can be achieved through the lateral surface over its entire length in axial direction of the screw.

In an embodiment which is simple to produce, provision is made that the edge of the lateral surface has at its second end an essentially circular circumference. The external diameter of the lateral surface is then constant at its second end and usually slightly smaller than the internal diameter of the cylinder, in which the screw rotates. A circular ring gap then occurs between lateral surface and cylinder.

As already explained, a portion of the melt, dependent on the number of apertures or bores and their diameters is pressed from the outer side of the lateral surface through the apertures or bores to the inner side of the lateral surface and flows from there through the discharge opening into the tool which is to be filled. The remainder of the melt flows in the material channel, becoming smaller in the direction of flow, between the outer side of the lateral surface and the inner wall of the cylinder and flows past the edge of the lateral surface through the annular gap to the discharge opening. Therefore, the edge of the lateral surface also offers the possibility to influence the flow at least of this remainder of the melt. In an improved embodiment, provision is therefore made that the edge of the lateral surface has a flow-influencing pattern at its second end, wherein the flow-influencing pattern comprises e.g. at least one notch or at least one tooth.

For the rheological reasons already mentioned, in particular for setting an essentially constant material throughflow through the lateral surface over its entire length in axial direction of the screw, provision is made in a further development of the mixing attachment according to the invention that the thickness of the lateral surface decreases from its first end to its second end.

Expediently, the axial length of the mixing attachment according to the invention from the first end to the second end of the lateral surface is essentially 1.5 times the diameter of the lateral surface at its second end.

The invention further relates to a screw, comprising a mixing attachment according to the invention as described above, and an extruder or respectively an injection-moulding machine, comprising such a screw.

An embodiment of the invention will be explained below with the aid of the single FIGURE as a non-restrictive example. Herein:

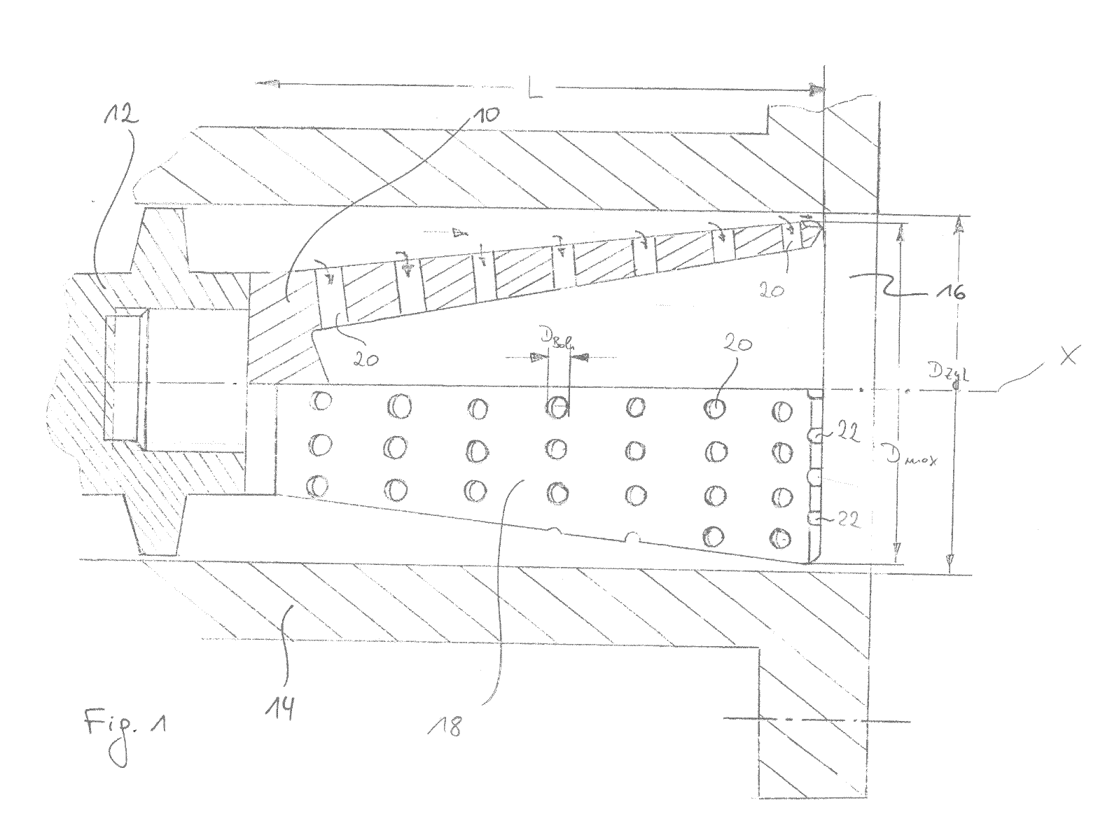

FIG. 1 shows a lateral view, partly in section, of an embodiment of the mixing attachment according to the invention with use on a screw of an extruder or respectively injection-moulding machine.

FIG. 1 shows a lateral view, partly in section, of a mixing attachment 10 according to the invention. It is secured by screwing at the downstream end, indicated partly in section on the left in the FIGURE, of a horizontally oriented screw 12 of an extruder or respectively injection-moulding machine. The cylinder 14 of the extruder or respectively injection-moulding machine is likewise illustrated in section, in which the screw 12 rotates, in order to discharge melted and compacted extrusion material through the discharge opening 16 on the right in FIG. 1 into a tool which is to be filled.

Above the rotation axis X of the screw 12, indicated by a dot-and-dash line in the FIGURE, and of the mixing attachment 10, the mixing attachment 10 is illustrated in section, beneath the rotation axis X not in section, i.e. the FIGURE shows here the outer side of its lateral surface 18.

In the embodiment illustrated in the FIGURE, the lateral surface 18 has essentially the shape of a horizontal truncated cone with the rotation axis X as central symmetry axis. At the left-hand first axial end of the lateral surface 18 in the FIGURE, its diameter corresponds essentially to that of the screw 12. The diameter of the lateral surface 18 therefore increases from its first axial end, on the left in the FIGURE, close to the downstream end of the screw 12, to its second axial end, on the right in the FIGURE, close to the discharge opening 16, essentially continuously up to a maximum diameter Dₘₐₓ. This is slightly smaller than the internal diameter D_{Zyl} of the cylinder 14.

Therefore, only an annular gap with a width of (D_{Zyl}−Dₘₐₓ)/2 remains for the melt conveyed by the screw 12, in order to flow past the downstream end of the lateral surface 18 of the mixing attachment 10 to the discharge opening 16. The majority of the melt flows through apertures 20 in the lateral surface 18 from its outer side to its inner side and from there to the discharge opening 16. In the present example embodiment, the apertures 20 are configured as bores 20. As the lateral surface 18 of the mixing attachment 10 according to the invention rotates together with the screw 12 during operation of the extruder or respectively injection-moulding machine, the material stream of the melt is divided hereby into a plurality of individual strands which are mixed with one another. This is indicated in the FIGURE by individual arrows. Hereby, the material- and temperature homogeneity of the melt are improved according to the invention.

In the embodiment illustrated in the FIGURE, the lateral surface 18 has in axial direction seven bores approximately in a row, the diameter D_{Boh} of which is greater than the width of the annular gap (D_{Zyl}−Dₘₐₓ)/2. Depending on the rheological characteristics of the extrusion material and/or resistance of the tool which is to be filled, the number of the bores 20 and/or their diameter D_{Boh} can also be selected differently. Likewise, it is possible to provide the bores 20, differently to in the FIGURE, not in a row in axial direction but rather for example running helically around the lateral surface 18.

The lateral surface 18 has at its second axial end, on the right in the FIGURE, a flow-influencing pattern in the form of several notches 22. These bring about an additional intermixing of the portion of the melt which flows through the annular gap between the lateral surface 18 and the inner wall of the cylinder 14. Alternatively or additionally to such notches 22, the flow-influencing pattern can also comprise one or more teeth which project from the lateral surface 18 radially outwards in the direction of the inner wall of the cylinder 14.

The mixing attachment 10 according to the invention can expediently have an axial length L in the direction of flow of the melt of approximately L=1.5*Dₘₐₓ. In practice, e.g. cylinders 14 with a diameter D_{Zyl} of approximately 90 mm are used. In this case, the diameter Dₘₐₓ of the lateral surface 18 can be expediently approximately 87 mm at its downstream second end, so that an axial length of the mixing attachment 10 of approximately 130 mm is expedient. At the same time, an annular gap of width (D_{Zyl}−Dₘₐₓ)2=2.5 mm remains between the lateral surface 18 and the inner wall of the cylinder 14 for a direct flowing past of the melt, bypassing the bores 20.

The total number of bores 20, which perforate the lateral surface 18 depends essentially on the diameter of the screw 12, which corresponds to the diameter of the lateral surface 18 at its first end, and on the length L of the lateral surface 18 in axial direction. With the above-mentioned exemplary values, expediently approximately 100 bores 20 can be provided distributed over the entire lateral surface 18. In practice, in extruders or respectively injection-moulding machines, screws are used in a diameter range of approximately 25 mm to approximately 265 mm, and mixing attachments 10 according to the invention which are suitable for this can be produced for this entire range, if applicable with a correspondingly smaller or greater total number of bores 20.

The mixing attachment 10 according to the invention makes possible in all embodiments an improved intermixing of the melt and therefore a better material- and temperature homogeneity of the extrusion material. For this, the lateral surface 18 does not imperatively have to have the frustoconical shape illustrated in the FIGURE, as long as its diameter increases in the direction of flow of the melt, which is also ensured in the case of a rotationally symmetrical lateral surface 18 with a stepped surface line. In addition, for reasons of ease of maintenance and the possibility of providing an extruder or respectively an injection-moulding machine for the processing of a different extrusion material with a different mixing attachment, it is in fact preferred if the mixing attachment 10 can be connected to the screw in a detachable manner by a detachable securing device such as e.g. a thread. However, a non-detachable securing device is basically also included by the invention, e.g. in the form of a welded connection, by which a single-piece configuration of a mixing attachment 10 according to the invention is realized as an integral tip of a screw 12.

What is claimed is:

1. A mixing attachment (10) for a screw (12), in particular an extruder screw (12) in an extruder or in an injection-moulding machine, comprising an essentially rotationally symmetrical lateral surface (18), the diameter of which increases from a first end to a second end of the lateral surface (18), and a securing device, which is provided in the region of the first end of the lateral surface (18), for securing the mixing attachment (10) at a downstream end of the screw (12), wherein the lateral surface (18) is perforated by a plurality of apertures (20), in particular bores (20).

2. The mixing attachment (10) according to claim 1, wherein the securing device comprises a thread.

3. The mixing attachment (10) according to claim 1, wherein the lateral surface (18) is formed at least partly in a frustoconical shape.

4. The mixing attachment (10) according to claim 1, wherein the apertures (20) are configured as bores (20).

5. The mixing attachment (10) according to claim 1, wherein at least a portion of the apertures (20) or bores (20) perforates the lateral surface (18) essentially orthogonally.

6. The mixing attachment (10) according to claim 1, wherein the diameter (D_{Boh}) of the apertures (20) or bores (20) is essentially identical.

7. The mixing attachment (10) according to claim 1, wherein the apertures (20) or bores (20) have different diameters (D_{Boh}).

8. The mixing attachment (10) according to claim 1, wherein the edge of the lateral surface (18) has at its second end an essentially circular circumference.

9. The mixing attachment (10) according to claim 1, wherein the edge of the lateral surface (18) has at its second end a flow-influencing pattern.

10. The mixing attachment (10) according to claim 9, wherein the flow-influencing pattern comprises at least one notch (22) or at least one tooth.

11. The mixing attachment (10) according to claim 1, wherein the thickness of the lateral surface (18) decreases from its first end to its second end.

12. The mixing attachment (10) according to claim 1, the axial length (L) of which from the first end to the second end of the lateral surface (18) is essentially 1.5 times the diameter (Dₘₐₓ) of the lateral surface (18) at its second end.

13. A screw (12), comprising a mixing attachment (10) according to claim 1.

14. An extruder or injection-moulding machine, comprising a screw (12) according to claim 13.
